(19) United States
(12) Patent Application Publication
(10) Pub. No.: US 2005/0166355 A1
(43) Pub. Date: Aug. 4, 2005

(54) Autonomous mobile robot cleaner

(75) Inventor: Takao Tani, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/043,084

(22) Filed: Jan. 27, 2005

(30) Foreign Application Priority Data
Jan. 30, 2004 (JP) 2004-022409

(51) Int. Cl. A47L 5/00

(52) U.S. Cl. 15/319

(57) ABSTRACT

An autonomous mobile robot cleaner that can thoroughly clean an area of high dust concentration. The robot cleaner includes a dust sensor to detect collected dust and a dust concentration decision means to decide degree of dust concentration in the area in which the main body of the robot cleaner moves based on an output of the dust sensor. The robot cleaner performs a basic cleaning operation while moving according to a predetermined movement procedure. When it finds an area in which the degree of dust concentration is above a given value using the dust concentration decision means during the basic cleaning operation, it additionally performs a local cleaning operation to move locally in such area after its movement in accordance with the basic cleaning operation.

### BACKGROUND OF THE INVENTION

1. Field of the Invention

The present invention relates to an autonomous mobile robot cleaner to clean rooms as it autonomously moves around.

2. Description of the Related Art

A known autonomous mobile robot cleaner (vacuum cleaner) operates as follows. When the robot cleaner detects an obstacle, it performs obstacle avoidance such that it repeats turning in a random direction and moving straight. When the amount of dust detected during this obstacle avoidance exceeds a given amount, the robot cleaner starts turning and performs patterned movement such that it moves spirally, gradually increasing the radius of the spiral. When the robot cleaner encounters or detects an obstacle during the patterned movement such as the spiral movement, it turns in a random direction and performs the obstacle avoidance again (refer to e.g. Japanese Laid-open Patent Publication 2002-78650).

A further known autonomous mobile robot cleaner operates as follows. The robot cleaner moves zigzag in a manner to leave uncleaned area between a forward path and a backward path. When the amount of dust detected during this zigzag movement exceeds a given amount, the robot cleaner starts turning and moves spirally, gradually increasing the radius of the spiral. When a given time period passes or the amount of the detected dust drops below the given amount during this spiral movement, the robot cleaner resumes the zigzag movement (refer to e.g. Japanese Laid-open Patent Publication 2002-204768).

Another known autonomous mobile robot cleaner operates as follows. The robot cleaner moves zigzag in a manner to leave uncleaned area between a forward path and a backward path. When the amount of dust detected during this zigzag movement exceeds a given amount, the robot cleaner starts turning and moves spirally, gradually increasing the radius of the spiral. When its movement area completely covers the entire uncleaned area between the forward path and the backward path, the robot cleaner resumes the zigzag movement (refer to e.g. Japanese Laid-open Patent Publication 2002-204769).

These conventional robot cleaners have the following problem. If there is a high concentration of dust dropped on or along a moving path of a robot cleaner when cleaning e.g. a room, there is a possibility that such dust cannot be collected in one movement of the robot cleaner. Thus, it is necessary to take countermeasures to thoroughly clean the area of high dust concentration. However, none of the robot cleaners disclosed in the above three references move more than once in the area of high dust concentration. They merely change the movement pattern to the spiral movement in place of the then movement pattern, when the amount of the detected dust exceeds a given amount. Accordingly, the above robot cleaners move only once in most of the area of high dust concentration, so that they cannot solve the above problem.

### SUMMARY OF THE INVENTION

An object of the present invention is to provide an autonomous mobile robot cleaner that can thoroughly clean an area of high concentration of dropped dust.

According to a first aspect of the present invention, the above object is achieved by an autonomous mobile robot cleaner having a main body, comprising: an obstacle detection means to detect an obstacle around the main body; a moving means to move and turn the main body; a cleaning means to clean an area in which the main body moves; a cleaning operation control means to control the moving means and the cleaning means based on an output of the obstacle detection means so as to clean, while moving the main body, the area in which the main body moves; a dust sensor to detect dust collected by the cleaning means; and a dust concentration decision means to decide degree of dust concentration in the area in which the main body moves based on an output of the dust sensor, wherein the cleaning operation control means performs a basic cleaning operation to move the main body according to a predetermined movement procedure, and wherein when an area exceeding a reference value in the degree of dust concentration is found using the dust concentration decision means, the cleaning operation control means performs a local cleaning operation to move the main body locally in the area exceeding the reference value in the degree of dust concentration after the cleaning operation control means moves the main body in accordance with the basic cleaning operation in the area exceeding the reference value in the degree of dust concentration.

According to the first aspect of the present invention, a room is cleaned in accordance with the basic cleaning operation in which the main body, hence autonomous mobile robot cleaner, moves on or along its moving path according to the predetermined movement procedure. When an area of high dust concentration is found or detected during the basic cleaning operation, such area is cleaned by the basic cleaning operation, and then further by the local cleaning operation. Thus, the area of high dust concentration is cleaned more than once or at least twice, so that the area of high dust concentration can be thoroughly cleaned.

Preferably, after the cleaning operation control means moves the main body of the autonomous mobile robot cleaner in accordance with the basic cleaning operation in the area exceeding the reference value in the degree of dust concentration, the cleaning operation control means temporarily stops the basic cleaning operation, performs the local cleaning operation, and resumes the basic cleaning operation, after the local cleaning operation, subsequently from where the cleaning operation control means temporarily stops the basic cleaning operation. Thereby, each time an area of high dust concentration is found, such area is cleaned both by the basic cleaning operation and the local cleaning operation. Thereafter, the basic cleaning operation is resumed from the position where the basic cleaning operation is temporarily stopped. Thus, efficient cleaning can be performed with useless movements of the autonomous mobile robot cleaner being reduced.

Preferably, the autonomous mobile robot cleaner further comprises a memory means to store information needed to control the movement of the main body, wherein the cleaning operation control means performs a basic cleaning operation to move the main body according to a predetermined movement procedure, wherein when it is decided using the dust concentration decision means that the degree of dust concentration exceeds a reference value during the basic cleaning operation, the cleaning operation control means stores then position of the main body, at the time the degree of dust concentration exceeds the reference value, as a first position in the memory means, wherein thereafter when it is decided using the dust concentration decision means that the degree of dust concentration becomes no larger than the reference value, the cleaning operation control means stores then position of the main body, at the time the degree of dust concentration becomes no larger than the reference value, as a second position in the memory means, wherein thereafter the cleaning operation control means temporarily stops the basic cleaning operation, and performs a local cleaning operation to move the main body spirally from a mid-point between the first position and the second position in inside area of a circle with a center at the mid-point and a radius substantially half the distance between the first position and the second position so as to clean the inside area of the circle, and wherein after the local cleaning operation, the cleaning operation control means resumes the basic cleaning operation subsequently from the second position.

According to the second aspect of the present invention, a room is cleaned in accordance with the basic cleaning operation in which the main body, hence autonomous mobile robot cleaner, moves on or along its moving path according to the predetermined movement procedure. The degree of concentration of dust in the area where it moves (whether the area is of high dust concentration or not) is decided based on an amount of dust collected during the basic cleaning operation. When an area where the degree of dust concentration is above the reference value (area of high dust concentration) is found or detected during the basic cleaning operation, the basic cleaning operation is temporarily stopped, and such area is further cleaned by the local cleaning operation. Thus, the area of high dust concentration, where much dust is dropped in concentration, is cleaned more than once or at least twice, so that the area of high dust concentration can be thoroughly cleaned.

Moreover, the local cleaning operation cleans the inside area of a circle: whose center is set at a mid-point between a position on a moving path of the autonomous mobile robot cleaner, at the time the degree of dust concentration exceeds a reference value, and a position on the moving path at the time the degree of dust concentration becomes no larger than the reference value; and whose radius is substantially half the distance from the above position, at the time the degree of dust concentration exceeds the reference value, to the above position at the time the degree of dust concentration becomes no larger than the reference value. Accordingly, areas of high dust concentration can be efficiently cleaned, neither insufficiently nor excessively.

Furthermore, each time an area of high dust concentration is found, such area is cleaned both by the basic cleaning operation and the local cleaning operation. Thereafter, the basic cleaning operation is resumed from the position where the basic cleaning operation is temporarily stopped. Thus, efficient cleaning can be performed with useless movements of the autonomous mobile robot cleaner being reduced.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1A is a schematic and perspective top plan view of an autonomous mobile robot cleaner according to an embodiment of the present invention;

FIG. 1B is a schematic and partially cutaway side view of the autonomous mobile robot cleaner;

FIG. 2 is a schematic and perspective front view of the autonomous mobile robot cleaner;

FIG. 3 is an electrical block diagram of the autonomous mobile robot cleaner;

Each of FIG. 4 through FIG. 6 is a flow chart showing a cleaning operation control process of the autonomous mobile robot cleaner;

FIG. 7A through FIG. 7D are schematic views showing examples of movements of the autonomous mobile robot cleaner; and

FIG. 8A through FIG. 8C are also schematic views showing examples of movements of the autonomous mobile robot cleaner.

### DESCRIPTION OF THE PREFERRED EMBODIMENTS

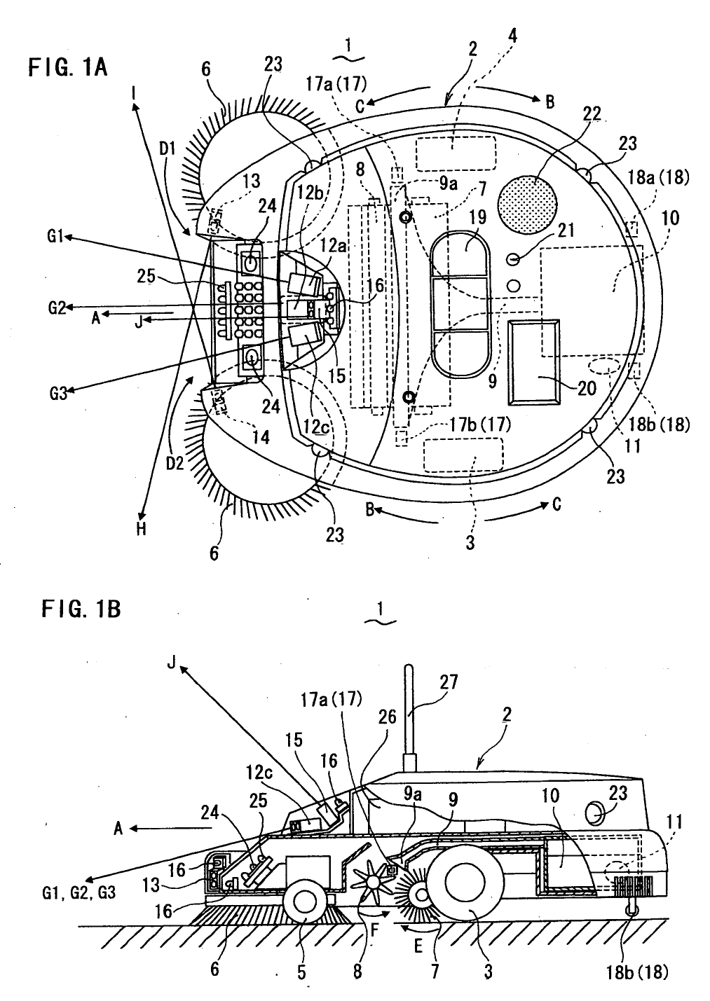

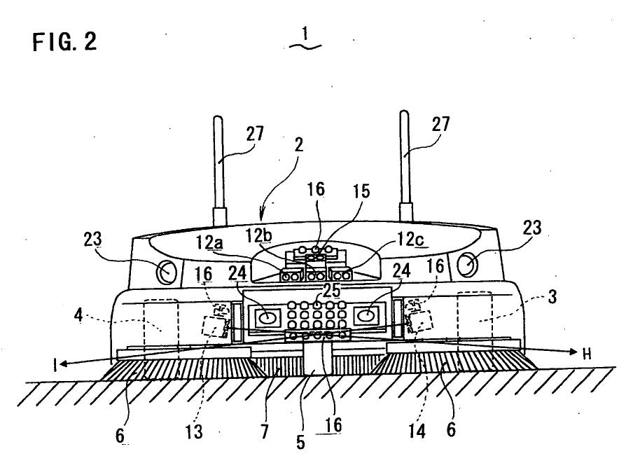

An embodiment of the present invention will be described hereinafter with reference to the annexed drawings. A schematic configuration of an autonomous mobile robot cleaner 1 (vacuum cleaner) according to the present embodiment is shown in FIG. 1A, FIG. 1B and FIG. 2. The autonomous mobile robot cleaner 1 is a device that autonomously moves on a floor of a room to clean the floor, and comprises: a main body 2; a left wheel 3, a right wheel 4 and a front wheel 5 to move the main body 2; and auxiliary brushes 6, a main brush 7, a roller 8, a suction nozzle 9, a dust box 10 and a suction fan 11 to collect dust, dirt and so on to be sucked or collected by a cleaner (hereafter collectively referred to simply as dust) e.g. dropped on the floor. The autonomous mobile robot cleaner 1 further comprises front sensors 12a, 12b and 12c, a left step sensor 13, a right step sensor 14, and a ceiling sensor 15 to detect obstacles around the main body 2 thereof, and sensor illumination lamps 16. An obstacle detection means according to the present embodiment comprises the front sensors 12a, 12b and 12c, the left step sensor 13, the right step sensor 14 and the ceiling sensor 15.

The left wheel 3 and the right wheel 4 are drive wheels that are independently rotated in normal rotation and reverse rotation, while the front wheel 5 is an idler wheel. The autonomous mobile robot cleaner 1 moves in a front (forward) direction (direction of arrow A shown in FIG. 1A and FIG. 1B) when both left wheel 3 and right wheel 4 are rotated in normal rotation at the same rotation speed. On the other hand, when one of the left wheel 3 and the right wheel 4 is rotated in normal rotation at an arbitrary position of the autonomous mobile robot cleaner 1 while the other is rotated in reverse direction at that position, the autonomous mobile robot cleaner 1 turns clockwise (direction of arrow B shown in FIG. 1A) or counterclockwise (direction of arrow C in FIG. 1A) at that position.

The auxiliary brushes 6 gather up the dust dropped on the floor, and two of them are provided at a front portion of the main body 2, that are respectively rotated in directions D1 and D2 shown in FIG. 1A. The main brush 7 gathers up the dust dropped on the floor to bring them upward, and is provided behind the auxiliary brushes 6 and rotated in direction E shown in FIG. 1B. The roller 8 transports the dust gathered up by the main brush 7 to the vicinity of a suction inlet 9a of the suction nozzle 9, and rotates in direction F shown in FIG. 1B, following the rotation of the main brush 7.

The suction nozzle 9 sucks the dust gathered up by the main brush 7 and the dust transported by the roller 8 from the suction inlet 9a, and exhausts them into the dust box 10. The suction inlet 9a of the suction nozzle 9 has a width elongated in a direction perpendicular to the moving direction (direction A shown in FIG. 1A and FIG. 1B). The dust box 10 collects the dust exhausted from the suction nozzle 9.

The suction fan 11 exhausts air in the dust box 10 outside the main body 2 via a filter. Due to the exhaustion of air in the dust box 10 outside the main body 2 by the suction fan 11, the dust together with air is sucked from the suction inlet 9a of the suction nozzle 9, and is exhausted into the dust box 10. While moving around, the autonomous mobile robot cleaner 1 gathers up dust by the auxiliary brushes 6, and sucks the dust by the suction nozzle 9, whereby it cleans the area it moves around, namely its movement area.

Each of the front sensors 12a, 12b and 12c, the left step sensor 13, the right step sensor 14 and the ceiling sensor 15 is an optical distance sensor. The front sensors 12a, 12b and 12c detect obstacles and measure distances to the obstacles that are positioned in front of the main body 2 such as a step, a wall, a pillar, a book put on the floor, a table, a chair and an electric fan. The front sensors 12a, 12b and 12c monitor the area in front of the main body 2 downward diagonally (in directions G1, G2 and G3 shown in FIG. 1A and FIG. 1B).

The left step sensor 13 detects and measures distances to obstacles that are similar to those above and located left of the main body 2, and monitors the area slightly in front of and left of the main body 2 downward diagonally (in direction H shown in FIG. 1A and FIG. 2). On the other hand, the right step sensor 14 detects and measures distances to obstacles that are similar to those above and located right of the main body 2, and monitors the area slightly in front of and right of the main body 2 downward diagonally (in direction I shown in FIG. 1A and FIG. 2).

The ceiling sensor 15 detects obstacles located above and in front of the main body 2 of the autonomous mobile robot cleaner 1 (as to whether or not it can pass through under a table, a bed or the like) and measures heights of and distances to the obstacles. The ceiling sensor 15 monitors the area in front of the main body 2 upward diagonally (in direction J shown in FIG. 1A and FIG. 1B). The sensor illumination lamps 16 illuminate the area around the main body 2 so that the front sensors 12a, 12b and 12c, the left step sensor 13, the right step sensor 14 and the ceiling sensor 15 can surely detect obstacles.

The autonomous mobile robot cleaner 1 further comprises: a dust sensor 17 to detect dust sucked by the suction nozzle 9; a carpet sensor 18 to detect whether or not the floor surface is carpet; an operating unit 19; an LCD (liquid crystal display) 20; an LED (light emitting diode) 21; and a speaker 22.

The dust sensor 17 is an optical transmission sensor comprising a light emitting unit 17a to emit light and a light receiving unit 17b to receive the light from the light emitting unit 17a. The light emitting unit 17a and the light receiving unit 17b are provided on both sides of and in the vicinity of the suction inlet 9a of the suction nozzle 9. When the suction nozzle 9 sucks dust, the dust passes through between the light emitting unit 17a and the light receiving unit 17b. The light emitted from the light emitting unit 17a and received by the light receiving unit 17b is obstructed by the dust. Based on the light obstruction, the dust sensor 17 detects the dust sucked by the suction nozzle 9.

The carpet sensor 18 is also an optical transmission sensor comprising a light emitting unit 18a to emit light and a light receiving unit 18b to receive the light from the light emitting unit 18a. The light emitting unit 18a and the light receiving unit 18b are provided in a manner that they are separated from each other in a direction perpendicular to the moving direction of the main body 2, and that they are positioned at a height to allow a slight gap between them and the surface of the floor. When the main body 2 moves on the carpet, the fibers of the carpet obstruct between the light emitting unit 18a and the light receiving unit 18b, so that the light emitted from the light emitting unit 18a and received by the light receiving unit 18b is obstructed thereby. Based on the light obstruction, the carpet sensor 18 detects that the floor surface is carpet.

The operating unit 19 is operated by a user to start and stop the cleaning operation of the autonomous mobile robot cleaner 1, and to make various other settings. The LCD 20 informs, by character display, operational states of the autonomous mobile robot cleaner 1 and various messages. The LED 21 informs operational states of the autonomous mobile robot cleaner 1 by its three modes: off, on and blinking. The speaker 22 informs, by audio output, operational states of the autonomous mobile robot cleaner 1 and various messages. These operating unit 19, LCD 20, LED 21 and speaker 22 are provided on an upper portion of the main body 2.

The autonomous mobile robot cleaner 1 furthermore has a security function of monitoring e.g. intruders, and comprises: human sensors 23 to detect e.g. the intruders; cameras 24 to photograph e.g. the intruders; camera illumination lamps 25; and a wireless communication module 26. The human sensors 23 detect presence or absence of a human body around the main body 2 of the autonomous mobile robot cleaner 1 by receiving infrared radiation from the human body. The cameras 24 are each provided to face in a direction diagonally forward and upward from the main body 2 so that they can photograph faces of standing humans. The camera illumination lamps 25 each illuminate in a direction diagonally forward and upward from the main body 2 (namely the photographing direction of the cameras 24) so as to enable sure photographing by the cameras 24. The wireless communication module 26 wirelessly transmits images photographed by the cameras 24 to e.g. a monitoring center via an antenna 27. When not in the cleaning operation, the autonomous mobile robot cleaner 1 operates these human sensors 23, cameras 24, camera illumination lamps 25 and wireless communication module 26 so as to monitor e.g. the intruders.

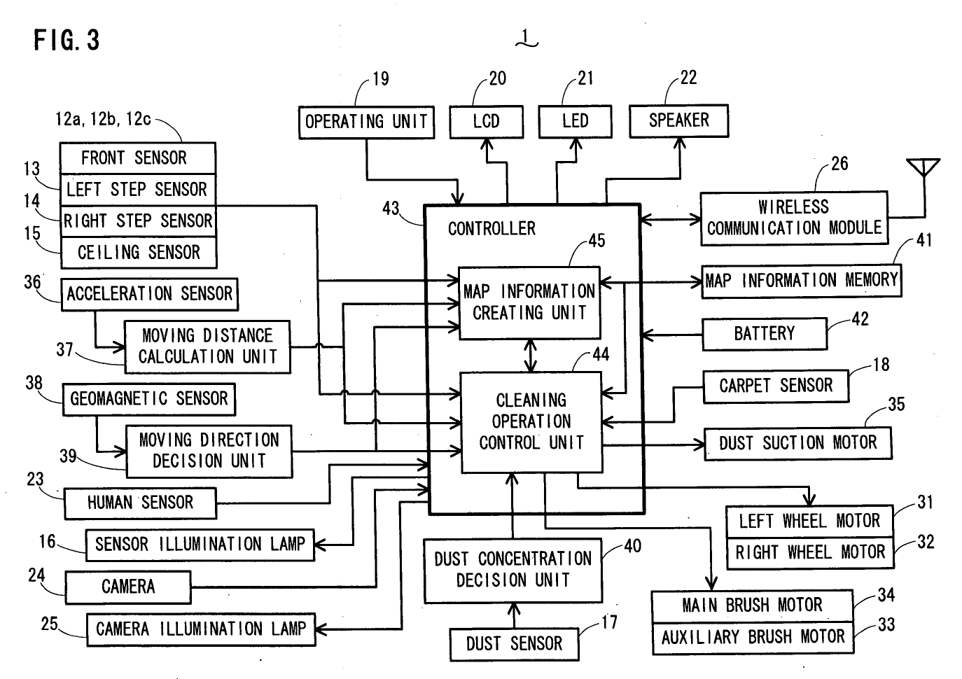

Referring now to FIG. 3 which shows an electrical block diagram of the autonomous mobile robot cleaner 1, its configuration and operation will be described. As described above, the autonomous mobile robot cleaner 1 comprises the front sensors 12a, 12b and 12c, the left step sensor 13, the right step sensor 14, the ceiling sensor 15, the sensor illumination lamps 16, the dust sensor 17, the carpet sensor 18, the operating unit 19, the LCD 20, the LED 21, the speaker 22, the human sensors 23, the cameras 24, the camera illumination lamps 25 and the wireless communication module 26. In addition to these, the autonomous mobile robot cleaner 1 comprises: a left wheel motor 31, a right wheel motor 32, an auxiliary brush motor 33, a main brush motor 34, a dust suction motor 35, an acceleration sensor 36, a moving distance calculation unit 37, a geomagnetic sensor 38, a moving direction decision unit 39, a dust concentration decision unit 40 (dust concentration decision means), a map information memory 41 (memory means), a battery 42 and a controller 43 to control the above respective units and elements.

A moving means according to the present embodiment comprises the left wheel motor 31, the right wheel motor 32 and the above described left wheel 3 and right wheel 4. A cleaning means according to the present embodiment comprises the auxiliary brush motor 33, the main brush motor 34, the dust suction motor 35, and the above described auxiliary brushes 6, main brush 7, roller 8, suction nozzle 9, dust box 10 and suction fan 11. Furthermore, a moving distance detection means according to the present embodiment comprises the acceleration sensor 36 and the moving distance calculation unit 37, while a moving direction detection means according to the present embodiment comprises the geomagnetic sensor 38 and the moving direction decision unit 39.

As described above, the front sensors 12a, 12b and 12c, left step sensor 13, the right step sensor 14 and the ceiling sensor 15 detect an obstacle, and measure the distance to the obstacle. The measured values are input to the controller 43. Under the control of the controller 43, the sensor illumination lamps 16 emit illumination lights. The dust sensor 17 detects dust as described above, and the detected signals, as outputs of the dust sensor 17, are input to the dust concentration decision unit 40. The carpet sensor 18 detects that the floor surface is carpet as described above, and the detected signals are input to the controller 43. The operating unit 19 outputs operation signals in accordance with operations of the operating unit 19 by a user, and the operation signals are input to the controller 43. Under the control of the controller 43, the LCD 20, the LED 21 and the speaker 22 inform operational states of the autonomous robot cleaner 1 and various messages.

The human sensors 23 detect presence or absence of a human body as described above, and the detected signals are input to the controller 43. Under the control of the controller 43, the cameras 24 photograph while the camera illumination lamps 25 emit illumination lights also under the control of the controller 43. Furthermore, under the control of the controller 43, the wireless communication module 26 wirelessly transmits images photographed by the cameras 24.

The left wheel motor 31 rotates the above left wheel 3 in both normal and reverse rotations, while the right wheel motor 32 rotates the above right wheel 4 also in both and reverse rotations. The auxiliary brush motor 33 rotates the above auxiliary brushes 6, while the, main brush motor 34 rotates the above main brush 7. The dust suction motor 35 rotates the above suction fan 11. These left wheel motor 31, right wheel motor 32, auxiliary brush motor 33, main brush motor 34 and dust suction motor 35 are respectively rotated under the control of the controller 43.

The acceleration sensor 36 detects accelerations acting on the main body 2, and outputs output values in accordance with the detected accelerations. More specifically, the acceleration sensor 36 independently detects accelerations acting on the main body 2 in up-down direction, forward-backward direction and left-right direction, respectively, and outputs output values in accordance with the detected accelerations in the up-down, forward-backward and left-right directions, respectively. The moving distance calculation unit 37 calculates a moving speed of the main body 2 based on the output value of the acceleration sensor 36 in the forward-backward direction, and calculates a moving distance of the main body 2 based on the calculated moving speed, and further outputs the calculated value of the moving distance.

The geomagnetic sensor 38 detects the geomagnetic field, and outputs output values in accordance with the direction of the geomagnetic field. Based on an output value of the geomagnetic sensor 38, the moving direction decision unit 39 decides the then direction in which the main body 2 faces, namely moving direction of the main body 2, using the direction of the geomagnetic field as a reference. The moving direction decision unit 39 then outputs output values corresponding to the moving direction of the main body 2.

The dust concentration decision unit 40 detects an amount of dust collection per a given time based on the output of the dust sensor 17, thereby deciding degree of dust concentration in an area over which the main body 2 moves. When the decided degree of dust concentration is above a reference value, the dust concentration decision unit 40 outputs a signal indicating to that effect. The map information memory 41 stores map information needed to control the movement of the main body 2, such as current position of the main body 2, position of an obstacle, already cleaned area, area of floor surface in which the degree of dust concentration is above the reference value, and so on. The battery 42 supplies power to the above respective units and elements.

The controller 43 controls the above respective units and elements, and comprises: a cleaning operation control unit 44 (cleaning operation control means) to control the cleaning operation; and a map information creating unit 45 to create map information. The cleaning operation control unit 44 controls the rotations of the left wheel 3 and the right wheel 4 by controlling the rotations of the left wheel motor 31 and the right wheel motor 32 so as to control the movement and turning of the main body 2. The cleaning operation control unit 44 further controls the rotations of the auxiliary brushes 6, the main brush 7 and the suction fan 11 by controlling the rotations of the auxiliary brush motor 33, the main brush motor 34 and the dust suction motor 35 so as to control the dust collection operation.

The cleaning operation control unit 44 controls the movement and the dust collection operation of the main body 2 based on the outputs of the front sensors 12a, 12b and 12c, the left step sensor 13, the right step sensor 14 and the ceiling sensor 15 and based on the map information stored in the map information memory 41. Thereby, the cleaning operation control unit 44 performs the cleaning operation while moving the main body 2. In the cleaning operation, the cleaning operation control unit 44 performs (1) a basic cleaning operation to move the main body 2 of the autonomous mobile robot cleaner 1 according to a predetermined movement procedure, and (2) a local cleaning operation to move the main body 2 locally in an area of high dust concentration. Based on the output of the carpet sensor 18, the cleaning operation control unit 44 controls the rotations of the left wheel motor 31 and the right wheel motor 32 so as to adjust the moving speed of the main body 2, and furthermore controls the rotations of the auxiliary brush motor 33, the main brush motor 34 and the dust suction motor 35 so as to adjust the dust collecting power.

The map information creating unit 45 calculates the position and moving direction of the main body 2 based on the outputs of the moving distance calculation unit 37 and the moving direction decision unit 39. Based on the thus calculated position and moving direction of the main body 2 as well as on the outputs of the front sensors 12a, 12b and 12c, the left step sensor 13, the right step sensor 14, the ceiling sensor 15 and the cleaning operation control unit 44, the map information creating unit 45 creates map information indicating the current position of the main body 2, the position of the obstacle, the already cleaned area, the area of floor surface in which the dust concentration is above the reference value, and so on. The map information created by the map information creating unit 45 is stored in the map information memory 41.

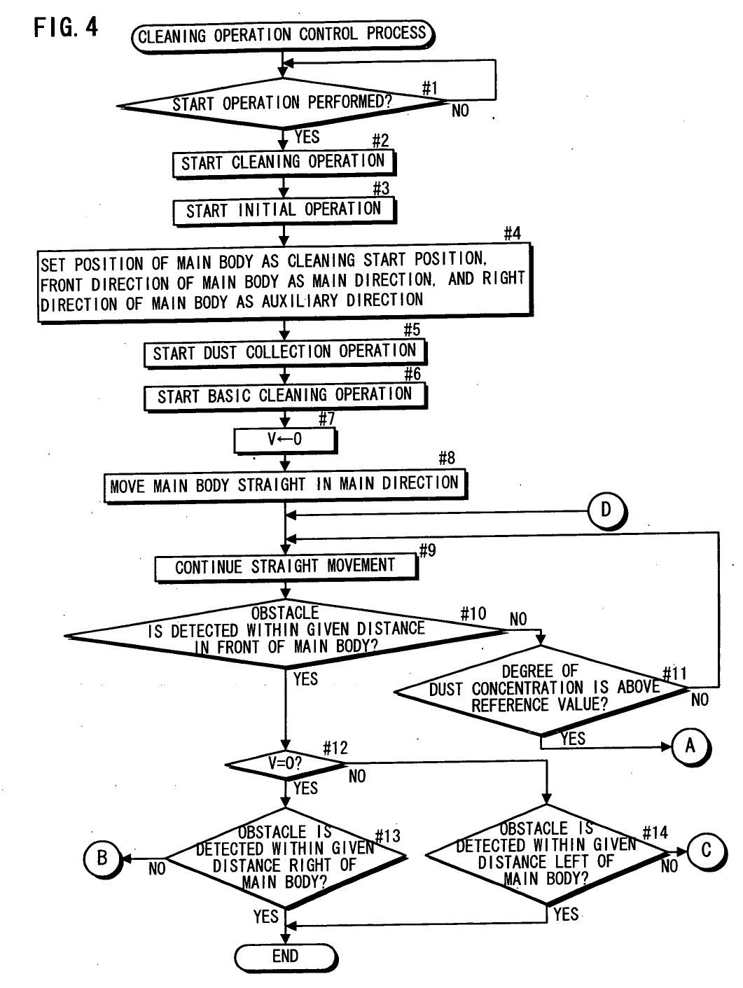

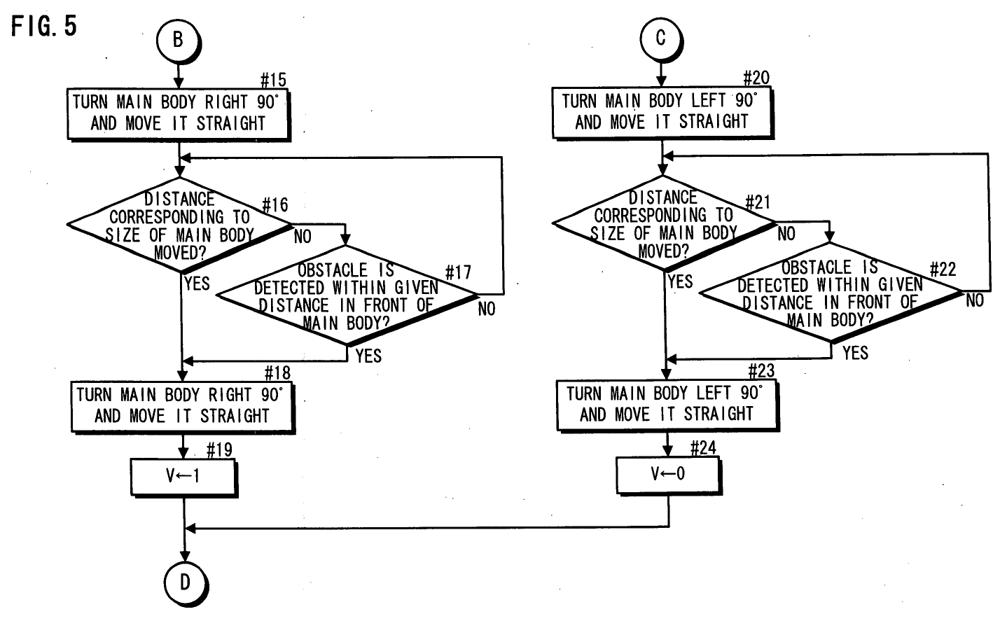

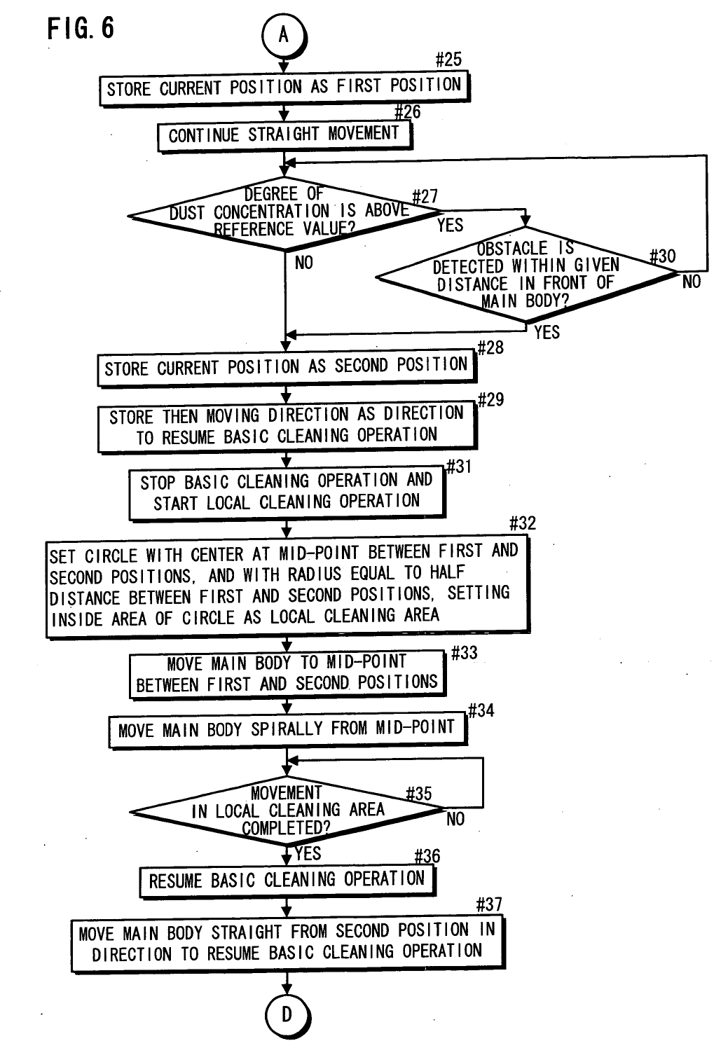

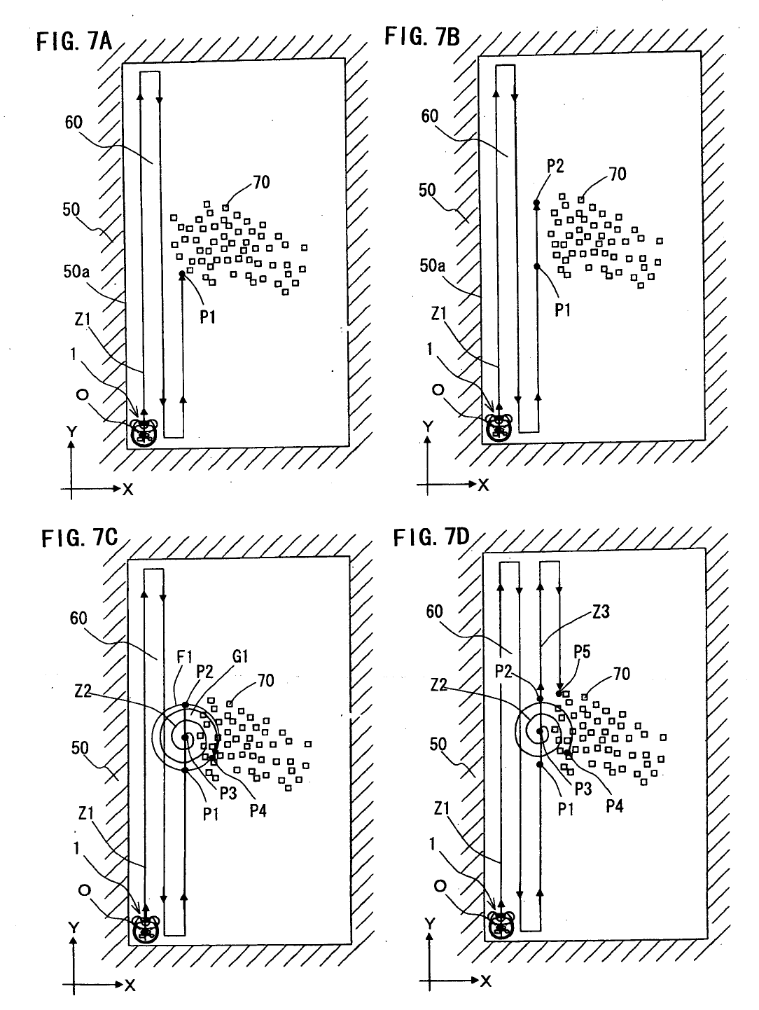

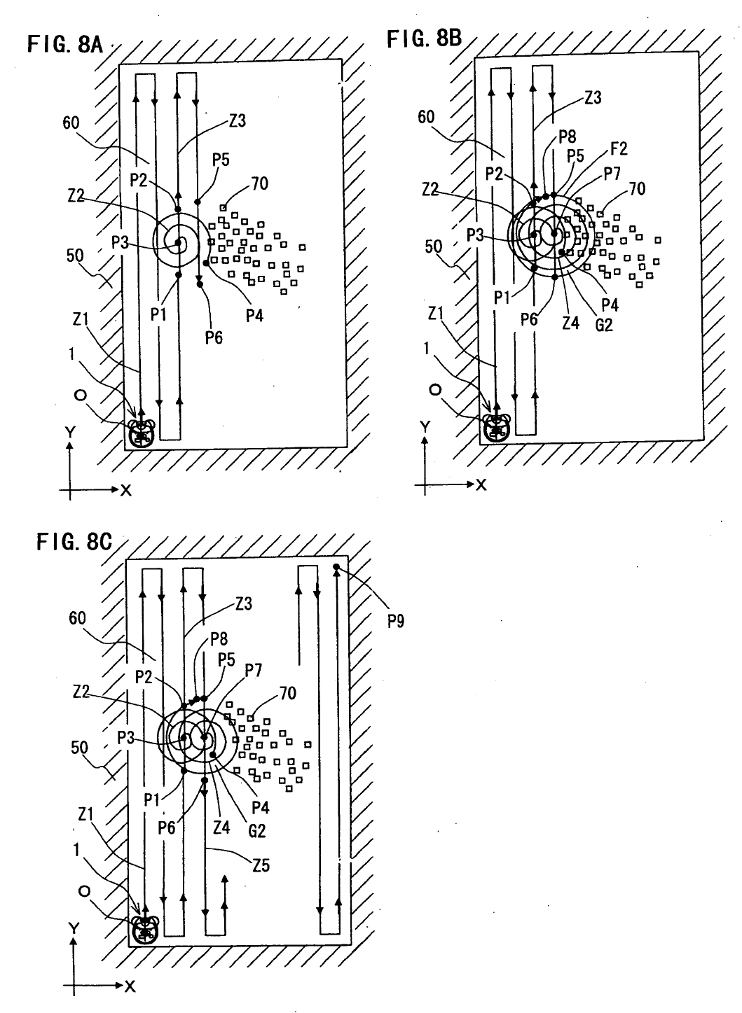

Hereinafter, the cleaning operation by the cleaning operation control unit 44 will be described with reference to the flow charts shown in FIG. 4 through FIG. 6 and to examples of movements of the autonomous mobile robot cleaner 1 as shown in FIG. 7A through FIG. 7D and FIG. 8A through FIG. 8C.

When the start operation to start the cleaning operation is performed (YES in #1), the cleaning operation control unit 44 starts the cleaning operation (#2). The start operation to start the cleaning operation is performed by operating the operating unit 19 with the autonomous mobile robot cleaner 1 being placed at an arbitrary position in a room. In the case of the example shown in FIG. 7A, the autonomous mobile robot cleaner 1 is initially placed at a point O (corner of room) in a room 60 surrounded by walls 50, with its front direction being in the X-direction (direction parallel to wall 50a).

After the start of the cleaning operation, the cleaning operation control unit 44 starts an initial operation (#3). At the initial operation, first of all, the position at which the main body 2 of the autonomous mobile robot cleaner 1 is placed is set as a cleaning start position, wherein the front direction of the main body 2 is set as a main direction, while the right direction of the main body 2 is set as an auxiliary direction (#4). In the example shown in FIG. 7A, the point O is set as the cleaning start position, and the Y-direction is set as the main direction while the X-direction perpendicular to the Y-direction is set as the auxiliary direction. The cleaning operation control unit 44 rotates the auxiliary brush motor 33, the main brush motor 34 and the dust suction motor 35 so as to start the dust collection operation (#5). Thereby, the initial operation ends.

The cleaning operation control unit 44 then starts the basic cleaning operation (#6). In the basic cleaning operation, the cleaning operation control unit 44 sets the value of a parameter “V” at “0” (#7), where the parameter “V” is provided to be used when the main body 2 of the autonomous mobile robot cleaner 1 encounters or detects an obstacle, in order to decide a moving direction of the main body 2 for avoiding the obstacle, that is to decide an avoidance direction. Next, the cleaning operation control unit 44 rotates the left wheel motor 31 and the right wheel motor 32 so as to move the main body 2 straight in the main direction (#8).

Thereafter, the cleaning operation control unit 44 continues the straight movement of the main body 2 (#9). Based on outputs of the front sensors 12a, 12b and 12c, and the ceiling sensor 15 during the straight movement of the main body 2, the cleaning operation control unit 44 judges whether or not they detect an obstacle within a given distance (for example 5 cm) in front of the main body 2 (#10). If no obstacle is detected (NO in #10), the cleaning operation control unit 44 judges, based on the output of the dust concentration decision unit 40, whether the degree of dust concentration in an area of the floor surface detected by the dust sensor 17 is above the reference value (#11). If the degree of dust concentration is not above the reference value (NO in #11), the cleaning operation control unit 44 repeats the processes from step #9 above onward.

If an obstacle is detected within the given distance in front of the main body 2 (YES in #10) while the processes of steps #9 to #11 above are repeated (namely while the autonomous mobile robot cleaner 1 moves straight), the cleaning operation control unit 44 first judges whether or not the value of “V” is “0” (#12). If the value of “V” is “0” (YES in #12), the cleaning operation control unit 44 judges, based on the output of the right step sensor 14, whether an obstacle is detected within a given distance (for example 5 cm) right of the main body 2 (#13). On the other hand, if the value of “V” is not “0” (NO in #12), the cleaning operation control unit 44 judges, based on the output of the left step sensor 13, whether an obstacle is detected within a given distance (for example 5 cm) left of the main body 2 (#14).

If NO in step #13 above, the cleaning operation control unit 44 turns the main body 2 right 90° at the then position, and moves the main body 2 straight (#15). Thereafter, if the main body 2 moves a distance corresponding to the size of the main body 2 (YES in #16), or if an obstacle is detected within the given distance in front of the main body 2 (YES in #17), the cleaning operation control unit 44 further turns the main body 2 right 90° at the then position, and moves the main body 2 straight (#18). Then, the cleaning operation control unit 44 sets the value of “V” at “1” (#19), and repeats the processes from step #9 onward.

If NO in step #14 above, the cleaning operation control unit 44 turns the main body 2 left 90° at the then position, and moves the main body 2 straight (#20). Thereafter, if the main body 2 moves a distance corresponding to the size of the main body 2 (YES in #21), or if an obstacle is detected within the given distance in front of the main body 2 (YES in #22), the cleaning operation control unit 44 further turns the main body 2 left 90° at the then position, and moves the main body 2 straight (#23). Then, the cleaning operation control unit 44 sets the value of “V” at “0” (#24), and repeats the processes from step #9 onward.

By repeating the processes of steps #9 to #24 above via step #11, so-called zigzag movements of the main body 2, hence the autonomous mobile robot cleaner, are performed such that when the main body 2 detects an obstacle while moving in the main direction, the main body 2 first moves in the auxiliary direction by a distance corresponding to the size of the main body 2, and then moves in a direction opposite to the main direction, and that when it detects an obstacle while moving in the direction opposite to the main direction, it first moves in the auxiliary direction by a distance corresponding to the size of the main body 2, and then moves in the main direction again. In the example shown in FIG. 7A, the autonomous mobile robot cleaner 1 moves zigzag along a route Z1 from the point O.

When the degree of dust concentration detected by the dust sensor 17 and decided by the dust concentration decision unit 40 exceeds the reference value while the processes of steps #9 to #11 above are repeated (namely while the autonomous mobile robot cleaner 1 moves straight) (YES in #11), the cleaning operation control unit 44 stores the then current position of the main body 2 (namely the position of the main body 2 at the time the degree of dust concentration of the floor surface exceeds the reference value) as a first position in the map information memory 41 (#25). Current positions of the main body 2, while it moves, are obtained by the map information creating unit 45 at all times, so that the cleaning operation control unit 44 stores, as the first position, the current position of the main body 2 obtained by the map information creating unit 45 at the time the degree of dust concentration exceeds the reference value. Then, the cleaning operation control unit 44 continues to allow the main body 2 to remain moving straight (#26).

Thereafter, based on the output of the dust concentration decision unit 40, the cleaning operation control unit 44 judges whether or not the degree of dust concentration of the floor surface is above the reference value (#27). If the degree of the dust concentration is not above the reference value (namely if it becomes no larger than the reference value) (NO in #27), the cleaning operation control unit 44 stores the then current position of the main body 2 (namely its position at the time the degree of dust concentration of the floor surface becomes no larger than the reference value) as a second position in the map information memory 41 (#28). The cleaning operation control unit 44 further stores the then moving direction of the main body 2 in the map information memory 41 as a direction to resume the basic cleaning operation (#29).

On the other hand, when an obstacle is detected within the given distance in front of the main body 2 (YES in #30) even if the degree of dust concentration of the floor surface is above the reference value (YES in #27), then a similar process is performed such that the cleaning operation control unit 44 stores the then current position of the main body 2 (namely its position at the time it detects the obstacle) as a second position in the map information memory 41 (#28), and further stores the then moving direction of the main body 2 in the map information memory 41 as a direction to resume the basic cleaning operation (#29).

In the example shown in FIG. 7A, at the time the autonomous mobile robot cleaner 1 passes through a point P1, it starts moving in an area of high concentration of dust 70, so that at such time the cleaning operation control unit 44 decides that the degree of dust concentration of the floor surface exceeds the reference value. Accordingly, this point P1 is stored as the first position. Thereafter, the autonomous mobile robot cleaner 1 further moves straight and passes through a point P2 as shown in FIG. 7B. At this time, the autonomous mobile robot cleaner 1 has passed through the area of high concentration of dust 70, so that at such time the cleaning operation control unit 44 decides that the degree of dust concentration of the floor surface has become no larger than the reference value. Accordingly, this point P2 is stored as the second position. At the same time, the Y-direction (main direction), that is the moving direction of the autonomous mobile robot cleaner 1 in which it passes through the point P2, is stored as the direction to resume the basic cleaning operation.

After the process of step #29 above, the cleaning operation control unit 44 temporarily stops the basic cleaning operation, and starts the local cleaning operation (#31). In the local cleaning operation, the cleaning operation control unit 44 sets a circle with a center at a mid-point between the first position and the second position, and with a radius equal to substantially half the distance between the first position and the second position, setting the inside area of the circle as a local cleaning area (#32). The cleaning operation control unit 44 moves the main body 2 to the mid-point between the first position and the second position (#33), and moves the main body 2 spirally from such mid-point (#34). Here, the pitch of the spiral is so selected that the main body 2 can move around thoroughly in the local cleaning area. When thereafter the movement of the main body 2 in the local cleaning area is completed (YES in #35), the cleaning operation control unit 44 resumes the basic cleaning operation (#36), and moves the main body 2 straight from the second position in the direction to resume the basic cleaning operation (#37), and then repeats the processes from step #9 above onward.

In the example shown in FIG. 7C, the cleaning operation control unit 44 sets a circle F1 with a center at the mid-point P3 between the point P1 and the point P2, and with a radius equal to substantially half the distance between the point P1 and the point P2, setting the inside area of the circle as a local cleaning area G1. The autonomous mobile robot cleaner 1 moves spirally from the point P3 along a route Z2 so as to clean the local cleaning area G1. When the autonomous mobile robot cleaner 1 reaches a point P4, it stops the spiral movement. Thereafter, as shown in FIG. 7D, it moves straight from the point P2 in the main direction, which is the direction to resume the basic cleaning operation, and moves zigzag along a route Z3.

The cleaning operation control unit 44 repeats the processes of steps #9 to #37 above, whereby the main body 2, hence the autonomous mobile robot cleaner 1, repeats such movements as to move zigzag in accordance with the basic cleaning operation, and to move spirally in accordance with the local cleaning operation in areas where the degree of dust concentration is above the reference value. If YES in #13 or YES in #14 above, it ends the cleaning operation.

In the example shown in FIG. 7D, when the autonomous mobile robot cleaner 1 moves zigzag from the point P2 along a route Z3, and passes through a point P5, then it moves again through the area of high concentration of dust 70. Thus, the cleaning operation control unit 44 decides that the degree of dust concentration of the floor surface exceeds the reference value at the time the autonomous mobile robot cleaner 1 passes through the point P5, so that the point P5 is stored in the map information memory 41 as a first position. Thereafter the autonomous mobile robot 1 continues to move straight as shown in FIG. 8A. When it passes through a point P6, it has passed through the area of high concentration of dust 70. Accordingly, at the time it passes through the point P6, the cleaning operation control unit 44 decides that the degree of dust concentration of the floor surface has become no larger than the reference value, so that this point P6 is stored in the map information memory 41 as a second position. Here, the moving direction of the autonomous mobile robot cleaner 1 in which it passes through the point P6 is a direction opposite to the Y-direction (direction opposite to the main direction), so that the direction opposite to the Y-direction is stored as a direction to resume the basic cleaning operation.

Then, as shown in FIG. 8B, similarly as in the local cleaning using the points P1, P2 and P3, the cleaning operation control unit 44 sets a circle F2 with a center at a mid-point P7 between the point P5 and the point P6, and with a radius equal to substantially half the distance between the point P5 and the point P6, setting the inside area of the circle as a local cleaning area G2. The autonomous mobile robot cleaner 1 moves spirally from point P7 along a route Z4 so as to clean the local cleaning area G2. When the autonomous mobile robot cleaner 1 reaches a point P8, it stops the spiral movement. Thereafter, as shown in FIG. 8C, it moves straight from the point P6 in a direction opposite to the main direction, which is the direction to resume the basic cleaning operation, and moves zigzag along a route Z5.

Subsequently, similar cleaning operations are performed. When the autonomous mobile robot cleaner 1 reaches a point P9, walls 50 (obstacles) are detected within a given distance each in front of and right of the main body 2, so that step #14 above decides YES, whereby the cleaning operations end.

As is evident from the foregoing, the autonomous mobile robot cleaner 1 performs cleaning based on a basic cleaning operation while moving zigzag, and decides degree of concentration of dust dropped on e.g. a floor (degree of dust concentration) based on an amount of dust collected during the basic cleaning operation. When an area of high dust concentration (area where the degree of dust concentration is above a reference value) is found or detected during the basic cleaning operation, such area is cleaned by the basic cleaning operation, and is further cleaned by a local cleaning operation while the autonomous mobile robot cleaner 1 moves spirally. Thus, the area of high dust concentration is cleaned more than once or at least twice. Accordingly, even if all dust on or along a moving path of the autonomous mobile robot cleaner 1 is not collected by the basic cleaning operation, the uncollected dust is collected by the subsequent local cleaning operation. Thereby, the area of high dust concentration is thoroughly cleaned.

Moreover, the local cleaning operation cleans the inside area of a circle: whose center is set at a mid-point between a position on a moving path of the autonomous mobile robot cleaner 1, at the time the degree of dust concentration exceeds a reference value, and a position on the moving path at the time the degree of dust concentration becomes no larger than the reference value; and whose radius is substantially half the distance from the above position, at the time the degree of dust concentration exceeds the reference value, to the above position at the time the degree of dust concentration becomes no larger than the reference value. Accordingly, areas of high dust concentration can be efficiently cleaned, neither insufficiently nor excessively.

Furthermore, each time an area of high dust concentration is found, such area is cleaned both by the basic cleaning operation and the local cleaning operation. Thereafter, the basic cleaning operation is resumed from the position where the basic cleaning operation is temporarily stopped. Thus, efficient cleaning is performed with useless movements of the autonomous mobile robot cleaner 1 being reduced.

It is to be noted that the present invention is not limited to the structures, configurations or processes of the above embodiments, and various modifications are possible. For example, the movement pattern in the basic cleaning operation is not limited to such pattern according to the movement procedure as represented by the processes of steps #9 to #24 above (so-called zigzag movement). It can be a spiral movement pattern or any arbitrary movement pattern. In addition, the spiral movement in the local cleaning operation can be clockwise spiral or counterclockwise spiral. Moreover, the movement pattern in the local cleaning operation is not limited to the spiral movement, and can be a movement pattern of moving along concentric circular paths or any arbitrary movement pattern.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-22409 filed in Japan dated Jan. 30, 2004, the contents of which are hereby incorporated by references.

1. An autonomous mobile robot cleaner having a main body, comprising:
an obstacle detection means to detect an obstacle around the main body;
a moving means to move and turn the main body;
a cleaning means to clean an area in which the main body moves;
a cleaning operation control means to control the moving means and the cleaning means based on an output of the obstacle detection means so as to clean, while moving the main body, the area in which the main body moves;
a dust sensor to detect dust collected by the cleaning means; and
a dust concentration decision means to decide degree of dust concentration in the area in which the main body moves based on an output of the dust sensor,
wherein the cleaning operation control means performs a basic cleaning operation to move the main body according to a predetermined movement procedure, and
wherein when an area exceeding a reference value in the degree of dust concentration is found using the dust concentration decision means, the cleaning operation control means performs a local cleaning operation to move the main body locally in the area exceeding the reference value in the degree of dust concentration after the cleaning operation control means moves the main body in accordance with the basic cleaning operation in the area exceeding the reference value in the degree of dust concentration.

2. The autonomous mobile robot cleaner according to claim 1,
wherein after the cleaning operation control means moves the main body in accordance with the basic cleaning operation in the area exceeding the reference value in the degree of dust concentration, the cleaning operation control means temporarily stops the basic cleaning operation, performs the local cleaning operation, and resumes the basic cleaning operation, after the local cleaning operation, subsequently from where the cleaning operation control means temporarily stops the basic cleaning operation.

3. The autonomous mobile robot cleaner according to claim 1, further comprising a memory means to store information needed to control the movement of the main body,
wherein the cleaning operation control means performs a basic cleaning operation to move the main body according to a predetermined movement procedure,
wherein when it is decided using the dust concentration decision means that the degree of dust concentration exceeds a reference value during the basic cleaning operation, the cleaning operation control means stores then position of the main body, at the time the degree of dust concentration exceeds the reference value, as a first position in the memory means,
wherein thereafter when it is decided using the dust concentration decision means that the degree of dust concentration becomes no larger than the reference value, the cleaning operation control means stores then position of the main body, at the time the degree of dust concentration becomes no larger than the reference value, as a second position in the memory means,
wherein thereafter the cleaning operation control means temporarily stops the basic cleaning operation, and performs a local cleaning operation to move the main body spirally from a mid-point between the first position and the second position in inside area of a circle with a center at the mid-point and a radius substantially half the distance between the first position and the second position so as to clean the inside area of the circle, and
wherein after the local cleaning operation, the cleaning operation control means resumes the basic cleaning operation subsequently from the second position.

4. The autonomous mobile robot cleaner according to claim 1, further comprising a human sensor for detecting an intruder, a camera for photographing the intruder, a camera illumination lamp, and a wireless communication module so as to have a security function of monitoring an intruder.
